(19) United States
(12) Patent Application Publication
(10) Pub. No.: US 2012/0254770 A1
(43) Pub. Date: Oct. 4, 2012

(54) MESSAGING INTERFACE

(76) Inventor: Eyal Ophir, Palo Alto, CA (US)

(21) Appl. No.: 13/077,845

(22) Filed: Mar. 31, 2011

(51) Int. Cl. G06F 3/048

(52) U.S. Cl. 715/752

(57) ABSTRACT

A message from a contact is received by a client and displayed in a message window for an amount of time. Additional messages from the same contact received are also displayed in the message window, and the size of the message window is adjusted to display additional messages with previous messages. After the amount of time expires, the message is removed from the message window and the size of the message window is adjusted again. To view the removed message, the user may select the message window, and the previously removed messages are displayed in a full message window.

### BACKGROUND

The disclosure generally relates to the field of user interfaces, in particular to a user interface for displaying received messages, such as instant or chat messages.

Numerous messaging platforms are now available, including those for instant messages or chat messages. In many of these platforms, a message window is displayed when a user receives a message from another user, who may be a contact of the user. The message window might display all of the recent messages sent between the two users. Conversations with additional contacts are sometimes displayed in separate message windows, and these separate windows can take up a significant portion of screen real estate. In addition, these windows often stay visible unless they are manually dismissed by the user.

As messages are received from multiple users of a messaging platform, the number of messaging windows displayed can accumulate and clutter the screen of a user. Typically, message windows cannot be closed or minimized without explicit interaction from the user. In addition, message windows can display multiple options and information that are unnecessary and increase the screen area occupied by a message window. Message windows also often steal focus and interrupt a task that was being performed.

### SUMMARY

A user of a client authenticates with one or more messaging platforms through a messaging server. After authentication, a message is transmitted from a contact associated with a messaging platform through a messaging server and then transmitted or pushed to the client. In response, the client displays the message in a temporary message window for a limited amount of time, which may be predetermined. If the temporary message window is selected by the user while the message is displayed, a full message window is displayed supplying the user with more features and controls. For example, the full message window may allow the user to send messages to the contact and view a history of messages between the user and the contact. If the temporary message window is not interacted with during the predetermined amount of time, the message is removed from the temporary message window and/or the temporary message window is minimize or closed. In this case, a small badge with the number of messages the user has not interacted with remains to indicate that such messages have been received.

Additional messages received from the same contact while the temporary message window is open may be displayed in the message window alongside messages that were previously received. The size of the temporary message window may increase as additional messages are received and displayed therein. Each of the messages is displayed for a limited amount of time in the absence of any user interaction with or selection of the temporary message window, and then they are removed from the temporary message window. In one embodiment, the size of the temporary message window reduces as messages are removed from the message window. When the temporary message window no longer contains messages, it is also removed.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

FIG. 1 illustrates one embodiment of a system for displaying messages on a client.

FIG. 2 illustrates one embodiment of a client that receives messages and displays the messages for a user.

FIG. 3 illustrates one embodiment of a method for receiving and displaying messages on the client.

FIG. 4 illustrates one embodiment of a graphical representation of a message window.

FIG. 5 illustrates one embodiment of a graphical representation of message windows displaying messages from two different senders.

FIG. 6 illustrates one embodiment of a graphical representation of a minimized message window.

FIGS. 7A-7D illustrate one embodiment of a graphical representation of a series of messages received at a client.

FIG. 8 illustrates one embodiment of a graphical representation of a full message window.

### DETAILED DESCRIPTION

The computing environment described herein displays messages without detracting from other activities of a user. The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

### System Environment

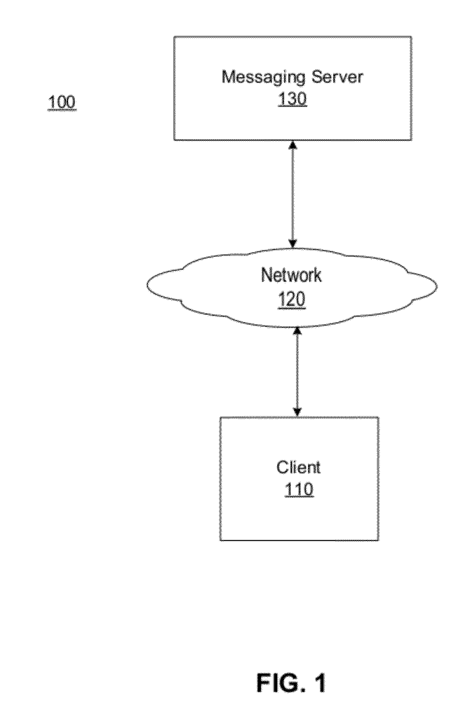

Referring to FIG. 1, the computing environment 100 for receiving and displaying messages comprises a client 110, a network 120, and a messaging server 130. The client 110 is a computing device with a processor and a memory capable of running applications including a web browser and/or a chat client. Examples of clients 110 include a desktop, a laptop, and a handheld computing device.

In one embodiment, the client 110 runs a web browser with an integrated chat client. Any other application that allows the client 110 to receive messages can operate using the principles described herein. In one embodiment, the browser includes messaging functionality that allows the user to send and receive messages using a dedicated messaging platform available to browser users. In another embodiment, the messaging platform also includes other messaging platforms to allow communications with users of clients other than the browser. A user may have user accounts with one or more messaging services or platforms. In one embodiment, a single login associated with the browser allows the user to login to multiple messaging services. Therefore, in one embodiment, the browser receives and displays messages addressed to the user through a plurality of messaging services.

The messaging server 130 is a computing system with a processor and a memory that receives and stores user data associated with the user. For example, the messaging server 130 associates other users of the messaging platform as a user's chosen contacts. Additionally, the messaging server 130 receives messages from the user's contacts and transmits them to the browser on user's client 110. Similarly, the messaging server 130 receives messages from the user's browser and transmits the received messages to their intended recipients' clients.

The network 120 represents the communication pathways between the client 110 and the messaging server 130. In one embodiment, the network 140 is the Internet. The network 140 can also use dedicated or private communication links that are not necessarily part of the Internet.

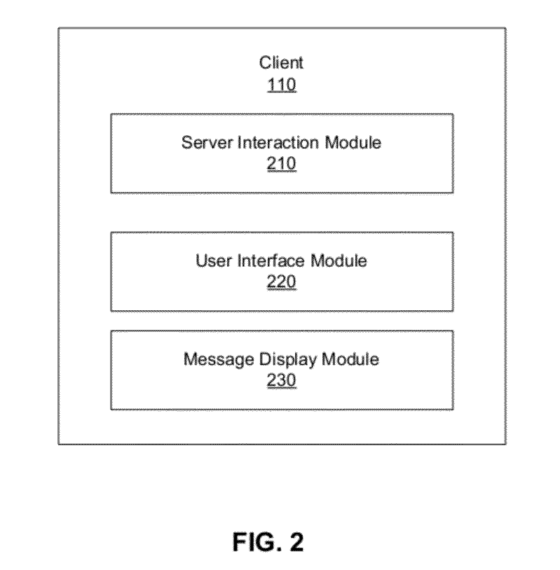

FIG. 2 illustrates an embodiment of the client 110, which comprises a server interaction module 210, a user interface module 220, and a message display module 230. The server interaction module 210 communicates with the messaging server 130 to authenticate a user of the client 110 and to receive messages from other users or contacts. The server interaction module 210 receives authentication data from the user and authenticates the user. The authentication data may comprise a user identification and optionally a corresponding password. The user identification and the password are alpha-numeric strings associated with the user. In one embodiment, the server interaction module 210 stores authentication data for one or more users, and the server interaction module 210 verifies the authentication data received from the user against the stored authentication data. In another embodiment, the server interaction module 210 transmits the authentication data to the messaging server 130 or another authenticating entity (not shown) and receives a verification of the authentication data. After the user is authenticated, the server interaction module 210 transmits the user's sent messages to the messaging server 130 and receives messages intended for the user.

The user interface module 220 provides an interface between the user and client 110 or the other modules in the client 110. In one embodiment, the user interface module allows the user to interact with and control a message window displayed on the client 110. For example, the user interface module 220 may allow the user to select a message window to open a full message window. In addition, the user interface module 200 may allow the user to minimize or close a message window or contact tab.

The message display module 230 receives messages from the messaging server 130 for the user through the server interaction module 210. In response to receiving a message, the message display module 230 displays the message in a temporary message window associated with the sender of the message or contact. When displaying a message, in one embodiment, the message display module 230 does not steal focus from another task being performed by the user. For example, the cursor does not move to the message window and the user is not interrupted by the message. This way, the user can respond to the message at an appropriate time of his choosing.

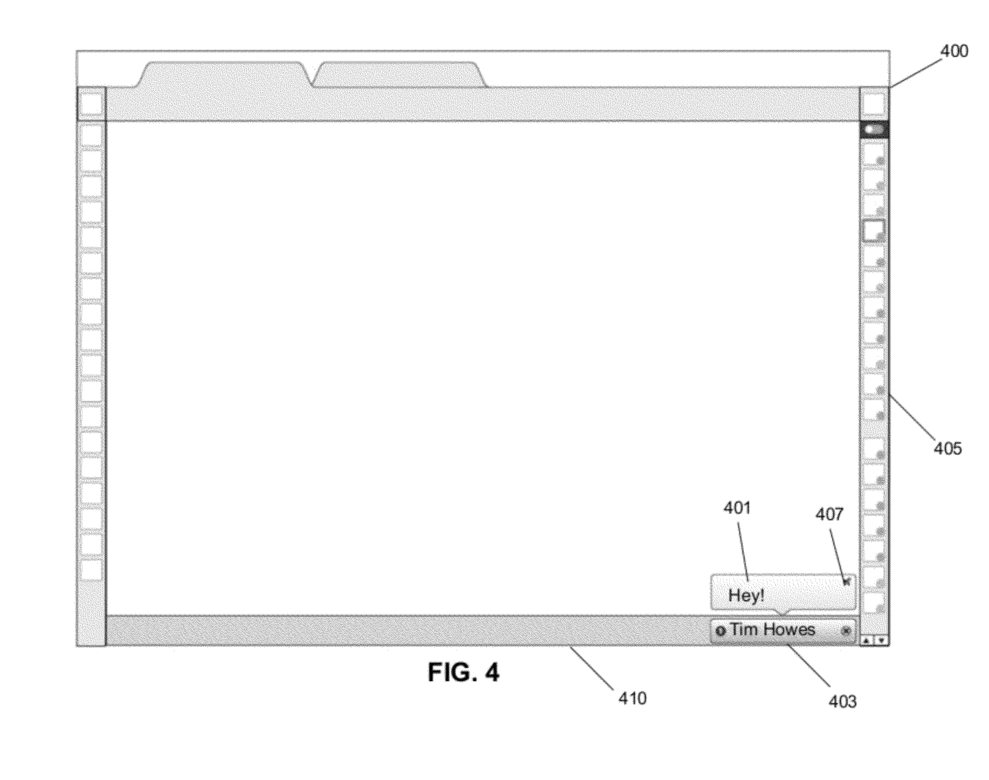

The message display module 230 may display little or no information besides messages in the temporary message window. This display beneficially limits the screen real estate consumed by the message window, while still delivering the contact's message to the user. In one embodiment, the message window also includes a mute icon, which, upon selection, dismisses the temporary message window and prevents further such windows from appearing until the user engages with the contact. The mute icon thereby allows a user to indicate that they have been sufficiently notified of the incoming chat, and to reduce distractions with little effort until they are ready to engage with the contact. A message window and mute button are illustrated in FIG. 4.

The message display module 230 displays messages in the message window for an amount of time, which may be predetermined. If the amount of time expires without the user selecting the message window or contact tab, the message display module 230 removes the message from the message window. If additional messages are received through the server interaction module 210 from the same contact, the message display module 230 displays the same messages in the message window associated with the contact tab. Each of the messages is displayed for a predetermined amount of time. If the predetermined amount of time elapses for a specific message, it is removed from the message window. If no messages remain displayed in the message window, the message window is minimized, and a badge or message counter may remain on the contact tab to indicate the number of unattended messages. Removing messages beneficially allows the message window to shrink and take up as little space as needed to display recently received messages. This reduces distractions to the user caused by incoming messages.

### Overview

Embodiments of the invention enable a user to view and use an instant message or chat interface from a web browser without cluttering the user's workspace. In one embodiment, a user launches a browser on client 110 and provides authentication information to the browser. The browser receives user input and authenticates the user with messaging server 130. After the user is authenticated, the browser determines and displays the status of user's contacts. At some point, one of the user's contacts may send a message to the user. The message is received by messaging server 130, and messaging server 130 transmits the received message to the browser on the user's client 110. The received message is displayed in a temporary pop-up message window. In one embodiment, the message window contains only the message itself, and the window does not interrupt the user by moving the cursor to the message window. Each received message is displayed for a predetermined amount of time and is then removed from the message window. If the user wants to view the recently removed messages, the user selects the message window and the previously removed messages are displayed with the current messages. As newer messages are displayed or older messages are removed, the message window expands or contracts to accommodate the number of messages displayed in the message window. Multiple message windows may be displayed, each corresponding to a different message sender.

This display of messages is beneficial because the displayed message windows use a small amount of screen real estate. Moreover, message windows do not steal focus from another task and avoid distracting the user. In addition, the message window automatically minimizes if all of the previously displayed messages have been removed from the window. This beneficially allows the user to view the message, and at the same time free screen real estate without explicitly dismissing or minimizing a message window.

### Chat Window Interface

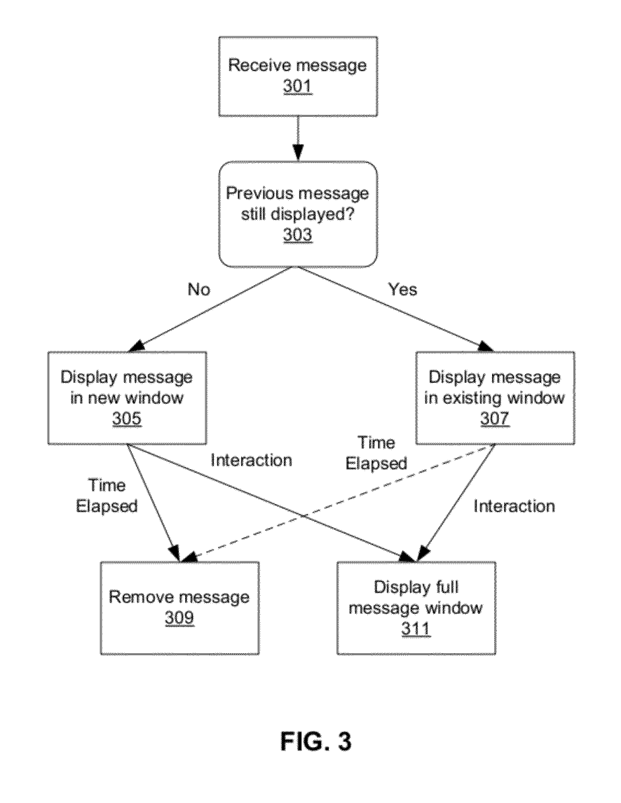

FIG. 3 illustrates one embodiment of a method for receiving and displaying messages on the client. A new message is received 301 through the messaging server 130 at the client 110 from a contact. FIG. 4 illustrates a graphical representation of a received message in one embodiment. Upon receiving an incoming message from a messaging platform for a user, the message display module 230 displays the message window 401 with the received message for the user.

In one embodiment, the message window 401 includes a mute button 407 that prevents future message windows from being displayed in response to receiving a message from the contact associated with a contact tab 403, until the user indicates that they are ready to engage the chat by clicking on the contact tab 403 associated with the contact. Additionally, the displayed message window 401 is associated with the contact tab 403 that represents the message sender. In one embodiment, contact tab 403 is located in a contact tab area 410, which contains any number of contact tabs, each contact tab associated with one of the user's contacts. Contact tabs may include a badge or message counter indicating the number of unseen messages in the case that the displayed message window has been dismissed due to an amount of time elapsing or user dismissing the message window via the mute button. In one embodiment, message functionality is included as part of a web browser 400. In another embodiment, this functionality is included in a messaging client like a chat client.

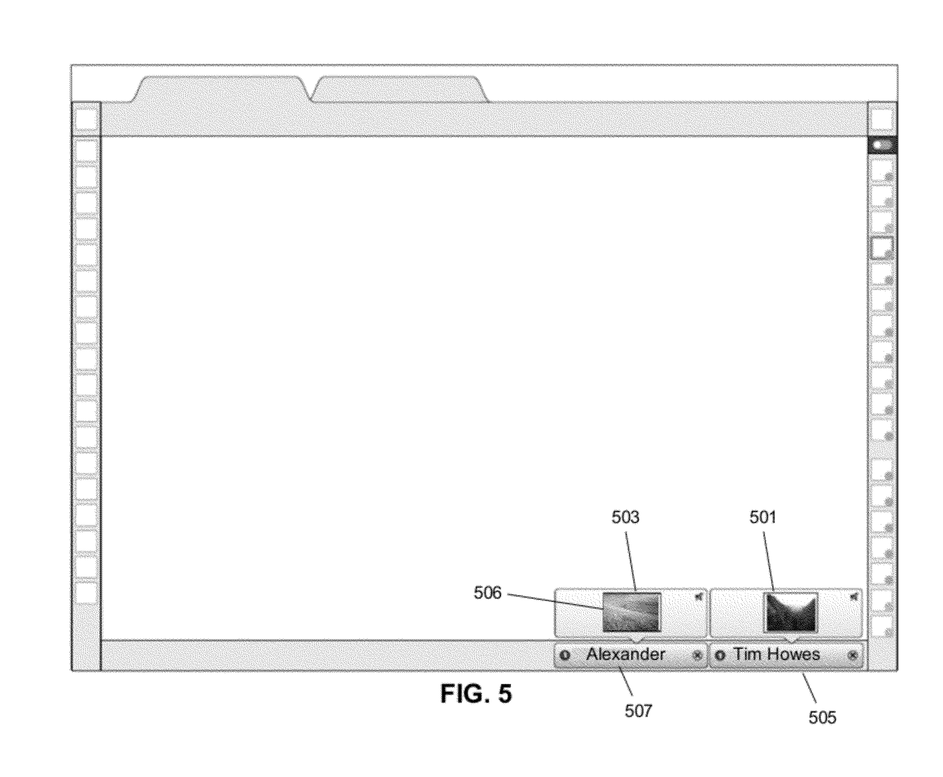

Referring back to FIG. 3. The client 110 then determines 303 if a previous message from the contact is displayed in an existing message window. If so, the new message is displayed 307 in the existing message window. The new message is placed above or below the existing messages, but typically the messages are listed in chronological order. If a previous message from the contact is not currently being displayed, the new message is displayed 305 in a new message window. This may result in displaying multiple message windows when receiving messages from multiple contacts as in FIG. 5.

As illustrated in FIG. 5, messages from different senders are displayed in different message windows. Multiple message windows 501 and 503 each correspond to messages from different senders. Because messages from different senders are displayed in separate windows, the displayed messages are kept separate and do not confuse the user regarding the identity of a message's sender. The sender's identity is displayed in a contact tab associated with each message window. One message window 501 is associated with a contact tab 505, and another message window 503 is associated with a contact tab 507.

Message windows, such as message window 501 and message window 503, are also capable of displaying images that have been received from a contact, such as an image 506. In one embodiment, the image 506 is a video or a thumbnail of a video, and a selection of the image 506 causes the video to play in the message window.

Now referring to FIG. 3, in one embodiment, regardless of whether the message is displayed in a new window or an existing window, after the predetermined amount of time expires, the new message is removed 309 from the message window. If no messages remain displayed in a message window, the message window is minimized or the window remains visible with the latest message until the window detects a user interaction.

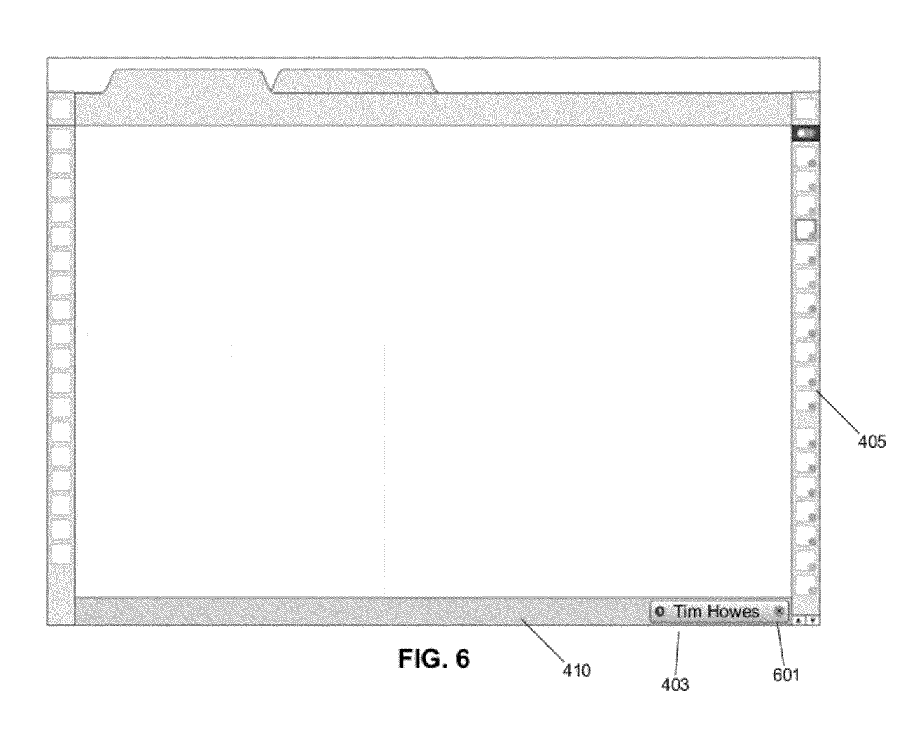

FIG. 6 illustrates one embodiment of a graphical representation of a minimized message window as discussed above. In response to the user selecting the mute button 407 or the user not interacting with the message window or associated the contact tab 403 for a predetermined time, the message window is minimized. In this instance, the message window 401 associated with the contact tab 403 has been minimized due to lack of user's interaction with the message window 401 within a predetermined time. Here, a badge is visible to indicate that the contact associated with this contact tab has sent the indicated number of messages to the user that the user has not yet interacted with. The predetermined amount of time that will result in a message window closing can be any length of time. A close tab button 601 causes the contact tab 403 to be closed. This removes the contact tab 403 from the contact tab area 410. In one embodiment, information previously accessed through selecting the contact tab 403 can be accessed by selecting an icon that is located in the message sidebar 405.

Referring back to FIG. 3, if the user interacts with a message window or corresponding contact tab, a full message window is displayed 311 with recently removed messages. The full message window allows the user to respond to the message and use additional features of the full message window. Additional messages received by client 110 from the same contact while the full message window for that contact is open are displayed in that full message window. Messages received by client 110 from other contacts are displayed in a temporary display window corresponding to those contacts' contact tabs as described above.

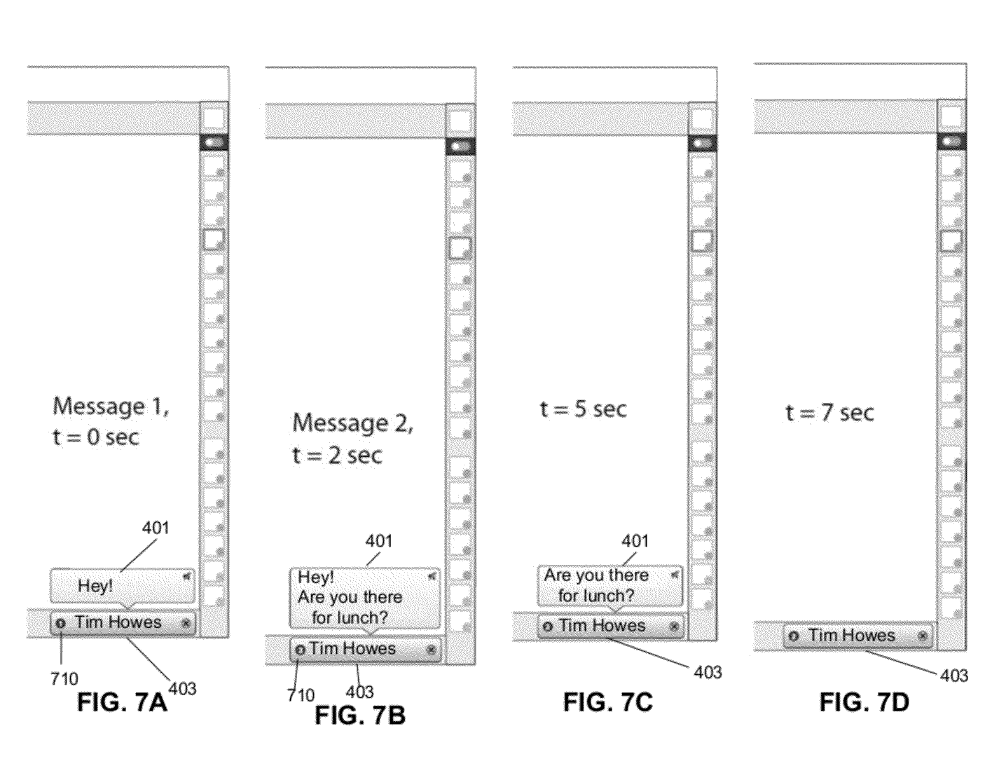

FIGS. 7A-7D illustrate one embodiment of a display window displaying and removing messages received in a conversation as discussed above. While specific time periods are mentioned, these are merely illustrative and any length of time may be used for any predetermined amount of time. Referring to FIG. 7A, at t=0 seconds, a message is received and displayed in the message window 401. In the associated the contact tab 403, a message counter 710 has been updated to reflect the number of messages that are in the current conversation associated with the contact tab 403. In one embodiment, the message counter 710 reflects the number of received messages, or the number of messages received but not yet directly interacted with by the user, or the number of messages both sent and received. Accordingly, the message counter 710 beneficially informs the user about the total number of messages in the current conversation even if some of the messages have been removed from the message window. In one embodiment, the message counter 710 is displayed in the message window 401. The user is thus aware of the received messages even if some have been removed from the window. If the user desires, the user may access the removed messages by selecting the message window and accessing the full message window.

In FIG. 7B, at t=2 seconds a second message is received from the contact associated with the contact tab 403. In response, the message window 401 is enlarged and the second message is displayed below the first message. The second message could also be displayed above the first message or anywhere in the message window 401. In one embodiment, the number of messages or lines of text included in a message window are limited. For example, the message window may limit message the window 401 to 10 lines. This would cause the most recently received messages to take priority and be displayed over older messages.

Now referring to FIG. 7C, at t=5, an amount of time has passed since the first message was displayed in the message window 401 and the first message is removed from the message window 401. In one embodiment, the message window 401 is resized to take up less screen real estate since less text is displayed. Again, in this example, 5 seconds is used as the amount of time, but any amount of time may be used. In FIG. 7D, at t=7, a second amount of time has passed since the second message was displayed in the message window 401 and the second message is removed from the message window 401. 5 seconds is used as the second amount of time. In addition, the amount of time used after the first message has been received need not be the same as the second amount of time considered after the second message has been received. For example, a message that causes a new message window to be displayed may be displayed for 10 seconds without interaction while a message that is added to a message window may be displayed for 7 seconds before removal.

In one embodiment, the message window 401 remains visible with the latest messages until the user interacts with the window by selecting, minimizing or closing the window. In one embodiment, selecting or interacting with a message window or contact tab results in a full message window being displayed containing additional messages from the conversation and additional options. If the message window is dismissed, messages can still be accessed by selecting the contact tab to bring up the full message window. By displaying a more complete list of messages only when a full message window is loaded, the space occupied by the initial message window is kept only large enough to display recently received messages.

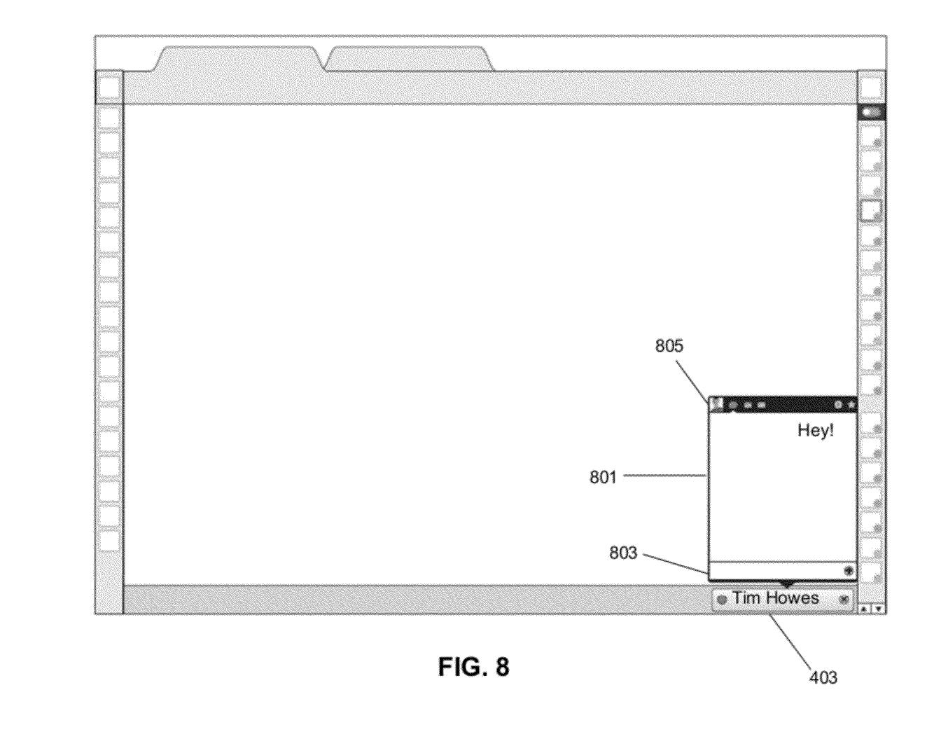

FIG. 8 illustrates one embodiment of a graphical representation of a full message window 801. Upon interacting with a message window or a contact tab, the full message window 801 is displayed. For example, upon interacting with the message window 401 or the contact tab 403, the full message window 801 is displayed and places focus, or puts the cursor, on an input box 803. The input box 803 allows the user to enter messages and respond to the contact associated with the contact tab 403. The full message window 801 allows the user to participate in the conversation by sending text, images or videos and contains other settings and features unavailable in the message window 401. For example, selecting a profile link 805 causes a web browser to open a profile or social networking website associated with the contact. Selecting the contact tab 403 allows the user to minimize or open the full message window 801.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, although described in terms of a web browser, embodiments of the chat interface may be provided in other types of applications, in standalone applications, or even in an operating system running on the client 110.

For example, the description about the browser or the client 110 and the messaging server 130 refers to particular functions performed by one entity or another. This description and the function assignment are for illustration purposes and do not limit the server or the client to their assigned functions. Upon reading this disclosure, one of ordinary skill in the art will understand that functions described in one embodiment as being performed on the server side can also be performed on the client side in other embodiments if appropriate. Similarly, the client side functions can be performed by the server if appropriate. Additionally, the functionality attributed to a particular component can be performed by different or multiple components operating together, as deemed appropriate by the implementer.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium including computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method for displaying received messages in an application, the method comprising:
receiving an instant message from a contact;
responsive to receiving the instant message, displaying a temporary message window;
displaying the received message in the temporary message window;
responsive to an amount of time having elapsed after displaying the received message, removing the received message from the temporary message window; and
responsive to a user selection of the temporary message window, displaying a full message window containing an instant message interface that enables a user to send messages to the contact.

2. The computer-implemented method of claim 1, further comprising:
receiving a second instant message from a second contact;
displaying a second temporary message window, wherein the second temporary message window is separate from the first temporary message window; and
displaying the second message in the second temporary message window.

3. The computer-implemented method of claim 1, wherein the application is a web browser.

4. The computer-implemented method of claim 1, wherein the full message window includes a link to a profile associated with the contact.

5. The computer-implemented method of claim 1, wherein the full message window comprises a history of previous messages exchanged with the contact.

6. The computer-implemented method of claim 1, further comprising:
receiving a second instant message from the contact while the temporary message window is displayed; and
displaying the second instant message in the temporary message window for a second amount of time.

7. The computer-implemented method of claim 6, wherein the temporary message window is increased to display both messages.

8. The computer-implement method of claim 6, wherein the size of the message window is decreased after removing the first message from the temporary message window.

9. The computer-implemented method of claim 6, wherein the message window displays a total number of messages previously removed and currently displayed in the message window.

10. A computer program product for displaying received messages in an application, the computer program product comprising a computer-readable storage medium containing computer program code for:
receiving an instant message from a contact;
responsive to receiving the instant message, displaying a temporary message window;
displaying the received message in the temporary message window;
responsive to an amount of time having elapsed after displaying the received message, removing the received message from the temporary message window; and
responsive to a user selection of the temporary message window, displaying a full message window containing an instant message interface that enables a user to send messages to the contact.

11. The computer program product of claim 10, further comprising computer program code for:
receiving a second instant message from a second contact;
displaying a second temporary message window, wherein the second temporary message window is separate from the first temporary message window; and
displaying the second message in the second temporary message window.

12. The computer program product of claim 10, wherein the application is a web browser.

13. The computer program product of claim 10, wherein the full message window includes a link to a profile associated with the contact.

14. The computer program product of claim 10, wherein the full message window comprises a history of previous messages exchanged with the contact.

15. The computer program product of claim 10, further comprising computer program code for:
receiving a second instant message from the contact while the temporary message window is displayed; and
displaying the second instant message in the temporary message window for a second amount of time.

16. The computer program product of claim 15, wherein the size of the message window is increased to display both messages.

17. The computer program product of claim 15, wherein after the size of the message window is decreased after removing the first message from the temporary message window.

18. The computer program product of claim 15, wherein the message window displays a total number of messages previously removed and currently displayed in the message window.
